(19) United States
(12) Patent Application Publication
(10) Pub. No.: US 2023/0306234 A1
(43) Pub. Date: Sep. 28, 2023

(54) METHOD FOR ASSESSING MODEL UNCERTAINTIES WITH THE AID OF A NEURAL NETWORK AND AN ARCHITECTURE OF THE NEURAL NETWORK

(71) Applicant: Robert Bosch GmbH, Stuttgart (DE)

(72) Inventors: Gerhard Neumann, Karlsruhe (DE); Michael Volpp, Stuttgart (DE)

(21) Appl. No.: 18/187,128

(22) Filed: Mar. 21, 2023

(30) Foreign Application Priority Data
Mar. 28, 2022 (DE) 10 2022-203 034.6

(51) Int. Cl. G06N 3/04

(52) U.S. Cl. CPC G06N 3/04

(57) ABSTRACT

A computer-implemented method for assessing uncertainties in a model with the aid of a neural network in particular, a neural process. The model models a technical system and/or a system behavior of the technical system. An architecture of the neural network for assessing uncertainties is also described.

### CROSS REFERENCE

The present application claims the benefit under 35 U.S.C. § 119 of German Patent Application No. DE 10 2022 203 034.6 filed on Mar. 28, 2022, which is expressly incorporated herein by reference in its entirety.

### FIELD

The present invention relates to a method for assessing uncertainties with the aid of a neural network and to an architecture of the neural network.

### BACKGROUND INFORMATION

In technical systems, in particular, in safety-critical, technical systems, models, in particular, models for active learning, reinforcement learning or extrapolation, may be used for predicting uncertainties, for example, with the aid of neural networks.

Neural networks are able to easily manage large amounts of training data sets and are computationally efficient at the training time. A disadvantage is that they provide no assessments for an uncertainty about their predictions and they may also tend to an over-adaptation in the case of small data sets. Furthermore, the problem may arise that the neural networks should be highly structured for their successful application and their size may rapidly increase above a certain complexity of the applications. This may place excessive demands on the hardware required for the application of the neural networks. Gaussian processes may be viewed as being complementary to neural networks, since they are able to provide reliable estimations for the uncertainty; however, their, for example, quadratic or cuboid scaling with the number of context data during the training time may severely limit the application on typical hardware in the case of tasks that include large amounts of data or in the case of high-dimensional problems.

In order to address the above-mentioned problems, methods have been developed, which relate to the so-called neural processes. Neural processes, also referred to as NPs, are essentially a family of architectures based on neural networks, NNs, which create probabilistic predictions for regression problems. These neural processes are able to combine the advantages of neural networks and Gaussian processes. Finally, they provide a distribution across functions (instead of one individual function) and represent a multi-task learning method (i.e., the method is trained simultaneously on multiple tasks). Moreover, these methods are based, in general, on the conditional latent variable (CLV) models, the latent variable being used for taking the global uncertainty into account.

NPs approximate the regression by learning to map a set of contexts of observed input-output pairs onto a distribution across regression functions. Each function models the distribution of the output in the case of an input, which is conditional upon the context. This is achieved by a training method including multiple tasks, one function corresponding to one task. The resultant model provides exact predictions for unknown target functions on the basis of only a few context observations.

### SUMMARY

A specific example embodiment of the present invention relates to a computer-implemented method for assessing uncertainties in a model with the aid of a neural network, in particular, of a neural process, the model modelling a technical system and/or a system behavior of the technical system. According to an example embodiment of the present invention, a model uncertainty is determined in one step, and a variance of an output of the model, also called output variance, being determined in a further step based on the model uncertainty.

According to the method according to the present invention, it is thus provided that the output variance is determined based on the model uncertainty. This is advantageous in that in this way, it may be ensured that the output variance σ_{y}² is neither a function of an input point x nor of the task, i.e., of a latent sample z. In most applications, data are distorted by noise, i.e., y=y′+∈, where ∈ may, in general, be modelled as a Gaussian-distributed variable, i.e., ∈˜N(∈|0,σₙ²). In the most frequent situations encountered, the noise is both homoscedastic, i.e., σₙ² is independent of input location x, as well as task-independent, i.e., σₙ² is independent of the specific target function. This means that σₙ² is a fixed constant. It should also be noted that from the perspective of the modeling, σ_{y}²=σₙ² is applicable, i.e. the output variance σ_{y}² must estimate the (generally unknown) noise variance.

According to one specific embodiment, it is provided that the model uncertainty is quantified by variance σ_{z}² of a latent spatial distribution p(z|D^{c}), D^{c} being a set of contexts of observations.

According to one specific embodiment of the present invention, it is provided that the model uncertainty is calculated as variance σ_{z}² of a Gaussian distribution via a latent variable z from a set of contexts D^{c} of observations, i.e., p(z|D^{c})=N(z|μ_{z},σ_{z}²). This latent distribution enables an estimation of the model uncertainty by variance σ_{z}². Such an estimate is, in principle not exact, but is subject to an uncertainty. This is the case when the set of contexts D^{c} is not informative enough to determine the function parameters, for example, due to the ambiguity of the task, for example, when multiple functions are able to generate the same set of context observations. This type of uncertainty is referred to as model uncertainty and is to be quantified by variance σ_{z}² of latent spatial distribution p(z|D^{c}). Variance σ_{z}² is specifically calculated via σ_{z}²=σ_{z}²(D^{c}) and p(z|D^{c})=N(z|μ_{z}(D^{c}),σ_{z}²(D^{c})).

According to one specific embodiment of the present invention, it is provided that a mean value μ_{z} of the Gaussian distribution is calculated via latent variable z from a set of contexts D^{c} of observations, i.e., p(z|D^{c})=N(z|μ_{z},σ_{z}²). This latent distribution enables an estimate of the function parameters by mean value μ_{z}. Mean value μ_{z} is specifically calculated via z=μz(D^{c}) and p(z|D^{c})=N(z|μ_{z}(D^{c}),σ_{z}²(D^{c})).

According to one specific embodiment of the present invention, it is provided that a mean value μ_{y} of the output is calculated. Mean value μ_{y} of the output may be calculated based on an input point x and on a latent sample z.

According to one specific embodiment of the present invention, it is provided that an uncertainty of the neural network, in particular, of the neural process, is predicted based on the model uncertainty and on the output variance. The prediction distribution is obtained by marginalizing latent variable z, i.e., by integrating p(y|x,D^{c})=∫p(y|x,z)p(z|D^{c})dz. The uncertainty prediction of the neural process thus results from a combination of the model uncertainty, quantified by variance σ_{z}² and output variance σ_{y}². In order to ultimately provide well-calibrated uncertainty predictions of the neural process, a well-calibrated estimate of the model uncertainty, i.e., of variance σ_{z}², and of output variance σ_{y}² are, in turn, required. This may be provided with the method described.

Further specific embodiments of the present invention relate to an architecture of a neural network, in particular, a neural process, the neural network being designed to carry out steps of a method according to the specific embodiments described for assessing uncertainties in a model, the model modeling a technical system and/or a system behavior of the technical system, the neural network including at least one decoder section, the decoder section being trained to determine a variance of an output of the model, also called output variance, based on a model uncertainty. Thus, it is provided that a parametrization of the decoder section includes the model uncertainty quantified by variance σ_{z}².

According to one specific embodiment of the present invention, it is provided that the neural network includes at least one encoder section, the encoder section being trained to determine the model uncertainty as a variance σ_{z}² and/or a mean value μ_{z} of a Gaussian distribution via a latent variable z from a set of contexts D^{c} of observations, i.e., p(z|D^{c})=N(z|μ_{z},σ_{z}²). Variance σ_{z}² may be provided to the decoder section.

According to one specific embodiment of the present invention, it is provided that the neural network includes at least one further decoder section, the further decoder section being trained to determine a mean value μ_{y} of the output based on an input point x and a latent sample z. Mean value μ_{y}, in particular, in combination with the output variance, provides an estimate of function parameters y.

Further specific embodiments of the present invention relate to a device that includes a neural network, in particular, a neural process, including an architecture according to the specific embodiments described, the device being designed to carry out steps of a method according to the specific embodiments described.

Further specific embodiments of the present invention relate to a use of a method according to the specific embodiments described and/or of a neural network, in particular, of a neural process, including an architecture according to the specific embodiments described for ascertaining an, in particular, inadmissible, deviation of a system behavior of a technical system from a standard value range.

An artificial neural network, to which input data and output data of the technical unit are fed in a learning phase, is useful in ascertaining the deviation of the technical system. As a result of the comparison with the input data and output data of the technical system, the corresponding links in the artificial neural network are created and the neural network is trained on the system behavior of the technical system.

In a prediction phase following the learning phase, the system behavior of the technical system may be reliably predicted with the aid of the neural network. For this purpose, input data of the technical system are fed to the neural network in the prediction phase and output comparison data are calculated in the neural network, which are compared with output data of the technical system. If this comparison reveals that the difference of the output data of the technical system, which are detected preferably as measured values, deviates from the output comparison data of the neural network and the deviation exceeds a limiting value, then an inadmissible deviation of the system behavior of the technical system from the standard value range is present. Suitable measures may thereupon be taken, for example, a warning signal may be generated or stored or sub-functions of the technical system may be deactivated (degradation of the technical unit). If necessary, it is possible in the case of the inadmissible deviation to go around to alternative technical units.

With the aid of the above-described method, it is possible to continuously monitor a real technical system. In the learning phase, the neural network is fed a sufficient number of pieces of information of the technical system both from its input side and from its output side, so that the technical system is able to be mapped and simulated with sufficient accuracy in the neural network. This allows the technical system to be monitored and a deterioration of the system behavior to be predicted in the following prediction phase. In this way, it is possible, in particular, to predict the remaining service life of the technical system.

### BRIEF DESCRIPTION OF THE DRAWINGS

Further features, possible applications and advantages of the description result from the following description of exemplary embodiments of the present invention, which are represented in the figures. All features described or represented in this case, alone or in arbitrary combination, form the subject matter of the present invention, regardless of their wording or representation in the description or in the figures.

FIG. 1 schematically shows a network including a mean value aggregation.

FIG. 2 shows an architecture of a neural process according to a first specific embodiment of the present invention.

FIG. 3 shows an architecture of a neural process according to a further specific embodiment of the present invention.

### DETAILED DESCRIPTION OF EXAMPLE EMBODIMENTS

A computer-implemented method for assessing uncertainties in a model with the aid of a neural network, in particular, of a neural process, is described below with reference to the figures, the model modeling a technical system and/or a system behavior of the technical system. According to the method, a model uncertainty is determined in a step, and a variance of an output of the model, also called output variance, is determined in a further step based on the model uncertainty.

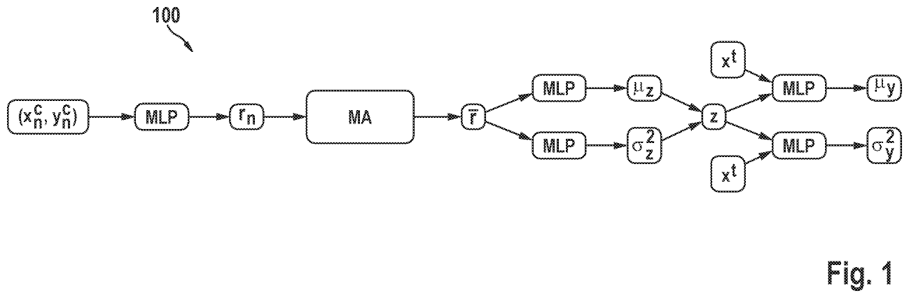

The determination of the model uncertainty is initially described with reference to FIG. 1.

The model uncertainty is quantified, for example, by a variance σ_{z}² of a latent spatial distribution p(z|D^{c}).

The model uncertainty, i.e., variance σ_{z}², is calculated as a variance of a Gaussian distribution and mean value μ_{z} of the Gaussian distribution via a latent variable z from a set of contexts D^{c} of observations, i.e., p(z|D^{c})=N(z|μ_{z},σ_{z}²).

Latent variable z is a task-specific latent random variable, which characterizes a probabilistic character of the entire model. Task indices are not used below for the sake of simplicity. For example, for two given observation tuples (x₁, y₁) and (x₂, y₂) of a one-dimensional quadratic function y=ƒ(x) as a set of contexts, the latent distribution should provide an estimate of a latent embedding of the function parameters, for example, parameters a, b, c in y=ax²+bx+c.

In principle, such an estimate is generally not exact, but is subject to an uncertainty. This is the case when the set of contexts D^{c} is not informative enough in order to determine the function parameters, for example, due to the ambiguity of the task. An ambiguity may be due to multiple functions generating the same set of context observations. This type of uncertainty is the uncertainty referred to as model uncertainty and quantified by variance σ_{z}² of latent spatial distribution p(z|D^{c}).

Since z is a global, i.e., a function of a variably large set of context tuples, latent variable, a form of aggregation mechanism is necessary in order to enable the use of context data sets D^{c} of variable size. To be able to represent a meaningful operation on data sets, such an aggregation must be invariant with respect to the permutations of context data points xₙ and yₙ. To meet this permutation condition, it is possible to use the traditional mean value aggregation schematically represented in FIG. 1.

FIG. 1 schematically shows a network 100 including a mean value aggregation (MA) from the related art with Likelihood Variation methods (VI), which are used in CLV models. Boxes labeled with MLP characterize multilayer perceptrons (MLP) that include a number of hidden layers. The box with the designation “MA” refers to the traditional mean value aggregation. The box labeled with z characterizes the implementation of a random variable with a random distribution, which is parametrized with parameters provided by the incoming nodes.

Each context data pair (xₙ, yₙ) is initially mapped by a neural network onto a corresponding latent observation rₙ. A permutation-invariant operation is then applied to generated set {rₙ}ₙ₌₁^{N} in order to obtain an aggregated latent observation r̅. One possibility in this context is the calculation of a mean value, namely, r̅=1/N·Σₙ₌₁^{N}rₙ. It should be noted that this aggregated observation r̅ is then used in order to parametrize a corresponding distribution for latent variables z.

As an alternative to the mean value aggregation, an aggregation may be determined for the latent variable z using Bayesian inference. This is described, for example, in M. Volpp, F. Flürenbock, L. Grossberger, C. Daniel, G. Neumann; “BAYESIAN CONTEXT AGGREGATION FOR NEURAL PROCESSES,” ICLR 2021.

From the related art, it is conventional to use a neural network or one neural network each, which calculates mean value μ_{y} and variance σ_{y}² of the parameters of the output distribution based on a target input position x and a sample z from the latent distribution. For example, M. Volpp, F. Flürenbock, L. Grossberger, C. Daniel, G. Neumann; “BAYESIAN CONTEXT AGGREGATION FOR NEURAL PROCESSES,” ICLR 2021 and H. Kim, A. Mnih, J. Schwarz, M. Garmelo, A. Eslami, D. Rosenbaum, O. Vinyals, Y. W. Teh; “Attentive Neural Processes,” https://arxiv.org/abs/1901.05761v2, describe parametrizing output variance σ_{y}² by an NN, which includes z and x as inputs. This may also be described by σ_{y}²=MLP(x,z).

However, this model is subject to the disadvantage that output variance σ_{y}² is a function of input point x and of latent sample z. This model is not quite correct for the following reason: in most applications, the data are subject to noise, i.e., y=y′+∈, where ∈ may be modeled as a Gaussian-distributed variable, i.e., ∈˜N(∈|0,σₙ²) with the mean value zero. In the following, the situation most frequently encountered in practice is assumed, namely, that the noise is both homoscedastic, i.e., σₙ² is independent of input location x and also task-independent, i.e., σₙ² is independent of the specific target function. This means that σₙ² is a fixed constant. From the perspective of the modeling σ_{y}²=σₙ² is applicable, i.e., output variance σ_{y}² is used in order to estimate the generally unknown noise variance. Thus, it is in fact advantageous if a model is used for an output variance σ_{y}² independent of z and x and output variance σ_{y}² is adapted during the training in order to estimate noise variance σ_{y}².

Thus, it provided according to the disclosure that σ_{y}²=MLP(σ_{z}²) is applicable.

The present invention is an improved way for parametrization of the output variance calculated by NN. In principle, this manner of parametrization may be applied to any NP-based architecture. Compared to the related art, the parametrization of that NN which calculates output variance σ_{y}² changes. It now no longer obtains a sample z and also no longer input location x, but latent variance σ_{z}² itself.

According to one specific embodiment of the present invention, it is provided that an uncertainty of the neural network, in particular, of the neural process, is predicted based on the model uncertainty and on the output variance. The prediction distribution is obtained by marginalizing latent variable z, i.e., by integration p(y|x,D^{c})=∫p(y|x,z) p(z|D^{c})dz. Thus, the uncertainty prediction of the neural process results from a combination of the model insecurity, quantified by variance σ_{z}² and from output variance σ_{y}². In order to ultimately provide well-calibrated uncertainty predictions of the neural process, a well-calibrated estimate of the model uncertainty, i.e., of variance σ_{z}², as well as of output variance σ_{y}² are, in turn, required. This may be provided using the method described.

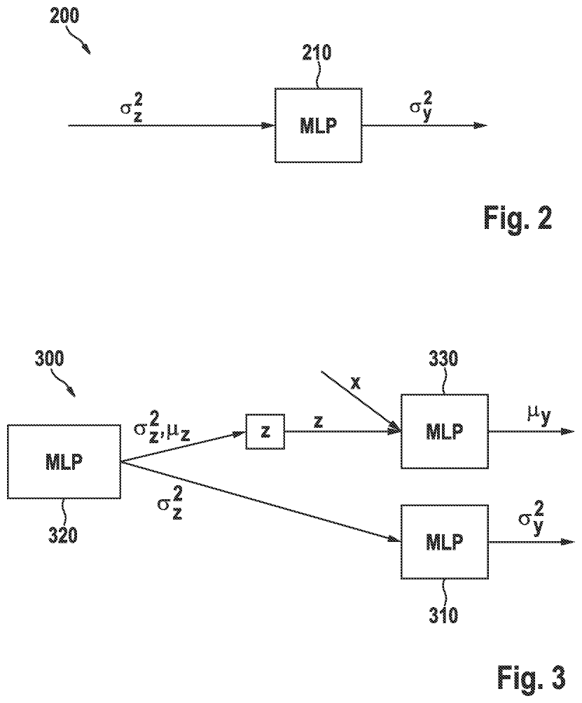

A simplified architecture is represented in FIG. 2.

FIG. 2 shows an architecture of a neural network 200, in particular, of a neural process, neural network 200 being designed to carry out steps of a method according to the specific embodiments described for assessing uncertainties in a model, the model modeling a technical system and/or a system behavior of the technical system.

Neural network 200 according to FIG. 2 includes a decoder section 210, the decoder section being trained to determine the variance of an output of the model based on model uncertainty σ_{z}², also output variance σ_{y}². It is thus provided that a parametrization of the decoder section includes the model uncertainty quantified by variance σ_{z}².

FIG. 3 shows a further specific embodiment of an architecture of a neural network 300. According to the specific embodiment, it is provided that the neural network includes a decoder section 310, which corresponds to decoder section 210 from FIG. 2. It is further provided that the neural network includes an encoder section 320, encoder section 320 being trained to determine the model uncertainty as variance σ_{z}² and/or as mean value μ_{z} of a Gaussian distribution via a latent variable z from a set of contexts D^{c} of observations, i.e., p(z|D^{c})=N(z|μ_{z},σ_{z}²). This takes place, for example, according to the above-described method on the basis of mean value aggregation. Variance σ_{z}² is then provided to decoder section 310.

According to the specific embodiment in FIG. 3, it is provided that neural network 300 includes a further decoder section 330, further decoder section 330 being trained to determine a mean value μ_{y} of the output based on an input point x and a latent sample z. Mean value μ_{z}, in particular, in combination with the output variance, provides an estimate of function parameters y.

Further specific embodiments relate to the use of the method according to the specific embodiments described and/or of a neural network, in particular, of a neural process, including an architecture according to the specific embodiments described for ascertaining an, in particular, inadmissible deviation of a system behavior of a technical system from a standard value range.

An artificial neural network, to which input data and output data of the technical unit are fed in a learning phase, is useful in ascertaining the deviation of the technical system. As a result of the comparison with the input data and output data of the technical system, the corresponding links in the artificial neural network are created and the neural network is trained on the system behavior of the technical system.

A plurality of training data sets used in the learning phase may include input variables measured at the technical system and/or calculated for the technical system. The plurality of training data sets may contain pieces of information relating to operating states of the technical system. In addition or alternatively, the plurality of training data sets may contain pieces of information regarding the surroundings of the technical system. In some examples, the plurality of training data sets may contain sensor data. The computer-implemented machine learning system may be trained for a certain technical system in order to process data (for example, sensor data) accruing in this technical system and/or in its surroundings and to calculate one or multiple output variables relevant for the monitoring and/or control of the technical system. This may take place during the design of the technical system. In this case, the computer-implemented machine learning system may be used for calculating the corresponding output variables as a function of the input variables. The data obtained may then be entered into a monitoring device and/or control device for the technical system. In other examples, the computer-implemented machine learning system may be used in the operation of the technical system in order to carry out monitoring tasks and/or control tasks.

The training data sets used in the learning phase may also be referred to as context data sets, [symbol] ₗ^{c}, according to the above [symbol] definition. The training data set (xₙ, yₙ) used in the present description (for example, for a selected index l where l=1 . . . L) may include the plurality of training data points and may be made up of a first plurality of data points xₙ and a second plurality of data points yₙ. The second plurality of data points, yₙ may be calculated in the same way, for example, using a given subset of functions from a general given function family [symbol] on the first plurality of data points, xₙ, as is discussed further above. For example, function family [symbol] may be selected in such a way that it is best suited for describing an operating state of a particular device under consideration. The functions and, in particular, the given subset of functions may also have a similar statistical structure.

In a prediction phase following the learning phase, the system behavior of the technical system may be reliably predicted with the aid of the neural network. For this purpose, input data of the technical system are fed to the neural network in the prediction phase and output comparison data are calculated in the neural network, which are compared with output data of the technical system. If this comparison reveals that the difference of the output data of the technical system, which are detected preferably as measured values, deviates from the output comparison data of the neural network, and the deviation exceeds a limiting value, then an inadmissible deviation of the system behavior of the technical system from the standard value range is present. Suitable measures may thereupon be taken, for example, a warning signal may be generated or stored or sub-functions of the technical system may be deactivated (degradation of the technical unit). If necessary, it is possible in the case of the inadmissible deviation to go around to alternative technical units.

With the aid of the above-described method, it is possible to continuously monitor a real technical system. In the learning phase, the neural network is fed with a sufficient number of pieces of information of the technical system both from its input side and from its output side, so that the technical system is able to be mapped and simulated with sufficient accuracy in the neural network. This allows the technical system to be monitored and a deterioration of the system behavior to be predicted in the following prediction phase. In this way, it is possible, in particular, to predict the remaining service life of the technical system.

Specific forms of application relate, for example, to applications in various technical devices and systems. For example, the computer-implemented machine learning systems may be used for controlling and/or for monitoring a device.

One first example relates to the design of a technical device or of a technical system. In this context, the training data sets may contain measured data and/or synthetic data and/or software data, which are important for the operating states of the technical device or of a technical system. The input data or output data may be state variables of the technical device or of a technical system and/or control variables of the technical device or of a technical system. In one example, the generation of the computer-implemented probabilistic machine learning system (for example, a probabilistic regressor or classifier) may include the mapping of an input vector of a dimension [symbol] ⁿ to an output vector of a second dimension [symbol] ^{m}. Here, for example, the input vector may represent elements of a time series for at least one measured input state variable of the device. The output vector may represent at least one estimated output state variable of the device, which is predicted based on the generated a posteriori predictive distribution. In one example, the technical device may be a machine, for example, an engine (for example, an internal combustion engine, an electric motor or a hybrid motor). In other examples, the technical device may be a fuel cell. In one example, the measured input state variable of the device may include a rotational speed, a temperature or a mass flow. In other examples, the measured input state variable of the device may include a combination thereof. In one example, the estimated output state variable of the device may include a torque, an efficiency, a pressure ratio. In other examples, the estimated output state variable may encompass a combination thereof.

The various input variables and output variables may include complex non-linear dependencies during the operation in a technical device. In one example, a parametrization of a characteristic diagram for the device (for example, for an internal combustion engine, an electric motor, a hybrid motor or a fuel cell) may be modeled with the aid of the computer-implemented machine learning systems of this description. The modeled characteristic diagram according to the present inventive method makes it particularly possible to quickly and accurately provide the correct correlations between the various state variables of the device during operation. The characteristic diagram modeled in this way may, for example, be used during operation of the device (for example, of the engine) for monitoring and/or for controlling the engine (for example, in an engine control device). In one example, the characteristic diagram may indicate how a dynamic behavior (for example, a power consumption) of a machine (for example, of an engine) is a function of various state variables of the machine (for example, rotational speed, temperature, mass flow, torque, efficiency and pressure ratio).

The computer-implemented machine learning systems may be used for classifying a time series, in particular, for classifying image data (i.e., the technical device is an image classifier). The image data may, for example, be camera data, LIDAR data, radar data, ultrasonic data or thermal image data (for example, generated by corresponding sensors). In some examples, the computer-implemented machine learning systems may be designed for a monitoring device (for example, of a manufacturing process and/or for quality assurance) or for a medical imaging system (for example, for findings of diagnostic data), or may be used in such a device.

In other examples (or in addition), the computer-implemented machine learning systems may be designed or used in order to monitor the operating state and/or the surroundings of an at least semi-autonomous robot. The at least semi-autonomous robot may be an autonomous vehicle (or another at least semi-autonomous means of transport or transportation means). In other examples, the at least semi-autonomous robot may be an industrial robot. For example, a precise probabilistic estimate of position and/or of velocity, in particular, of the robotic arm, may be determined with the aid of the described regression using data of position sensors and/or of velocity sensors and/or of torque sensors, in particular, of a robotic arm. In other examples, the technical device may be a machine or a group of machines (for example, of an industrial plant). For example, an operating state of a machine tool may be monitored. In these examples, output data y may contain information regarding the operating state and/or the surroundings of the respective technical device.

In further examples, the system to be monitored may be a communication network. In some examples, the network may be a telecommunication network (for example, a 5G network). In these examples, input data x may contain utilization data in nodes of the network and output data y may contain information regarding the allocation of resources (for example, channels, bandwidth in channels of the network or other resources). In other examples, a network malfunction may be recognized.

In other examples (or in addition), the computer-implemented machine learning systems may be designed or used for controlling (or regulating) a technical device. The technical device may, in turn, be one of the devices discussed above (or below) (for example, an at least semi-autonomous robot or a machine). In these examples, output data y may contain a control variable of the respective technical system.

In still other examples (or in addition), the computer-implemented machine learning systems may be designed or used in order to filter a signal. In some cases, the signal may be an audio signal or a video signal. In these examples, output data y may contain a filtered signal.

The method for generating and applying computer-implemented machine learning systems of the present description may be carried out on a computer-implemented system. The computer-implemented system may include at least one processor, at least one memory (which may contain programs which, when they are executed, carry out the method of the present description), and at least one interface for inputs and outputs. The computer-implemented system may be a stand-alone system or a distributed system, which communicates via a network (for example, the Internet).

The present description also relates to computer-implemented machine learning systems, which are generated using the method of the present description. The present description also relates to computer programs, which are configured to carry out all steps of the method of the present description. The present description further relates to machine-readable media (for example, optical memory media or read-only memories, for example, FLASH memories), on which computer programs are stored, which are configured to carry out all steps of the method of the present description.

What is claimed is:

1. A computer-implemented method for assessing uncertainties in a model using a neural network including a neural process, the model modeling a technical system and/or a system behavior of the technical system, the method comprising:
determining a model uncertainty σ_{z}²; and
determining a variance of an output of the model σ_{y}² based on the model uncertainty.

2. The method as recited in claim 1, wherein the model uncertainty is quantified by a variance of a latent spatial distribution p(z|D^{c}).

3. The method as recited in claim 1, wherein the model uncertainty is calculated as a variance σ_{z}² of a Gaussian distribution, where σ_{z}²=σ_{z}²(D^{c}), via a latent variable z from a set of contexts D^{c} of observations, wherein p(z|D^{c})=N(z|μ_{z}(D^{c}),σ_{z}²(D^{c})).

4. The method as recited in claim 3, wherein a mean value ν_{z} of the Gaussian distribution, where μ_{z}=μ_{z}(D^{c}), is calculated via the latent variable z from the set of contexts D^{c} of observations, wherein p(z|D^{c})=N(z|μ_{z}(D^{c}),σ_{z}²(D^{c})).

5. The method as recited in claim 1, wherein a mean value μ_{y} of the output is calculated.

6. The method as recited in claim 1, wherein an uncertainty of the neural network is predicted based on the model uncertainty and on the variance of the output.

7. An architecture of a neural network including a neural process, the neural network being configured for assessing uncertainties in a model, the model modeling a technical system and/or a system behavior of the technical system, the neural network comprising:
at least one decoder section trained to determine a variance of an output of the model based on a model uncertainty.

8. The architecture as recited in claim 7, wherein the neural network includes at least one encoder section, the encoder section being trained to determine the model uncertainty as a variance σ_{z}² and/or a mean value μ_{z} of a Gaussian distribution via a latent variable z from a set of contexts D^{c} of observations, where p(z|D^{c})=N(z|μ_{z},σ_{z}²).

9. The architecture as recited in claim 7, wherein the neural network includes at least one further decoder section, the further decoder section being trained to determine a mean value μ_{y} of the output based on an input point x and on a latent sample Z.

10. A device that includes a neural network including a neural process, the neural network being configured for assessing uncertainties in a model, the model modeling a technical system and/or a system behavior of the technical system, the neural network including at least one decoder section trained to determine a variance of an output of the model based on a model uncertainty.

11. The method as recited in claim 1, further comprising ascertaining an inadmissible deviation of the system behavior of the technical system from a standard value range based on the variance of the output of the model.
